(19) United States
(12) Patent Application Publication
(10) Pub. No.: US 2004/0237279 A1
(43) Pub. Date: Dec. 2, 2004

(54) Method and system for clamping metal frames of wire or steel strip onto the edges of mattress spring units made of springs, which are connected to each other by

(76) Inventor: Penagiotis Anagnostopoulos, Athens (GB)

Correspondence Address: John F Hoffman, Baker & Daniels, Suite 800, 111 East Wayne Street, Fort Wayne, IN, 46802, US

(21) Appl. No.: 10/481,777

(22) PCT Filed: Jun. 27, 2002
(86) PCT No.: PCT/GR02/00040

(30) Foreign Application Priority Data
Jun. 27, 2001 (GR) 20010100306

(51) Int. Cl. B23P 11/00; B21D 39/00

(52) U.S. Cl. 29/505; 29/715

(57) ABSTRACT

This invention refers to a method and a system for the fastening of wire or strip steel (1), (2) onto the outer side of the springs (3), which form the edges of an innerspring unit with metal clamps (4), where the springs are connected too each other with a metal spiral or are pocketed in cloth or non woven, which fastening is achieved by a number of presses equal to the number of springs we want to fasten and which presses are actuated simultaneously or gradually.

### TECHNICAL FIELD OF THE INVENTION

This invention refers to a method and a system for the clamping with metal clamps (4) of wire or steel strip (1), (2) onto the external side of springs (3), which form the edges of a mattress innerspring unit and are connected to each other by means of a steel spiral or are pocketed in cloth or non-woven, which is achieved by means of a number of presses proportional to the number of springs which we want in each operation to fasten and which operate simultaneously or sequentially.

### LEVEL OF PREVIOUS ART

The known methods for the fastening of pre-made wire frame onto the edges of innerspring units are two.

The most wide-spread one is the following: initially, the wire frame is made manually or by automatic machines, which join the two ends of the wire, in which case the frame is closed. Following this, the closed frame is positioned onto the innerspring unit and with an air-powered mechanism the frame is fixed onto each of the peripheral springs with a metal clip, which is made of thin sheet metal or steel strip.

This process requires the continuous displacement of the metal innerspring unit in such a fashion that the one after the other the springs and the frame will enter the mechanism for spring-frame fastening with clips of thin steel strip.

This way, after all edges of one side are fastened, the one after the other, the inner spring unit is rotated 180° around a horizontal axis and the same process is followed for the other four edges.

The second method is the following: a spiral of approximately 10 mm in diameter, made of wire 1 mm in diameter is advanced by a continuous helical rotation around its longitudinal axis and encloses the round-wire frame while it joins it with the external sides of the innerspring unit springs in such a way that they are entrapped and held together.

Both methods have the following disadvantages: all work is manual and tedious and has high labor costs. A trained worker can only produce 120-170 innerspring units per shift.

It, also, lacks in final product quality because it is very difficult to achieve exact dimensions of the edges and parallelity of the edges and of the flat surfaces of the innerspring unit. As the frames are fastened to the perimeter, parallelity of the innerspring unit's sides cannot be achieved because during processing, it is moved manually and takes different positions, resulting in innerspring unit distortion after completion of fastening. One more drawback is that this work demands trained operators.

### PRESENTATION OF THE DRAWINGS

FIGS. 1 and 2 show the final products of the method and the machine.

FIG. 3 shows the particular form of connecting frame, wire of steel strip to the springs of the innerspring unit.

FIGS. 4a to 4f show the basic idea of producing the innerspring unit with springs and wire frames.

FIGS. 5a and 5b show the side view and the top view of an application of the method as a machine.

FIG. 6 shows the mechanisms that produce the metal clamps for fastening the round wire or the flat steel strip of the frame to the innerspring unit's spring.

FIG. 7 shows the array of the machine's presses.

FIG. 8 shows the detail of mattress rotation.

FIG. 9 shows the press base with the two presses in the open position.

FIG. 10 shows the press base with metal clamps being fed to the stationary tool of the presses.

FIG. 11 shows the press base with its two presses clamping and thus fastening the wire or steel strip frame to the innerspring unit's springs by means of the metal clamps.

FIG. 12 shows the mechanisms for the displacement of the press bases.

FIG. 13 shows the press base with the presses for the automatic displacement of the press bases.

FIG. 14 shows a schematic of the press tasks.

FIG. 15 shows a side view of the displacement mechanism for the press bases.

FIG. 16 shows an alternative construction for the press base displacement mechanism.

FIG. 17 shows the principle of the automatic translation of the press bases.

FIG. 18 shows the application of the method in case of pocketed springs.

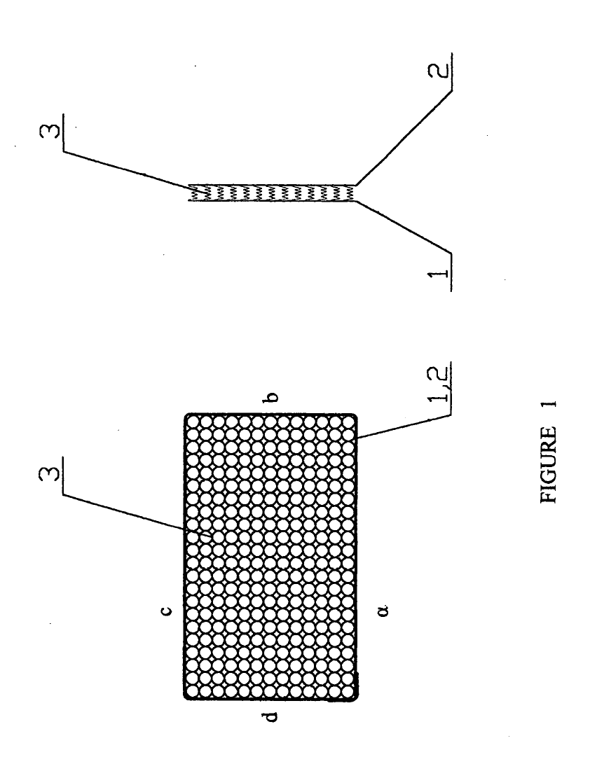

### DISCLOSURE OF THE INVENTION

The intention of the present invention is to overcome the problems mentioned and offer and automated method for the production of perfect product at high production rates.

With the proposed method the machines that produce the closed frames are not needed any longer. With the new method the round wire or the flat steel strip is advanced towards the innerspring unit and then it (the wire or the steel strip) is fastened to it (innerspring unit). The wire or the steel strip is taken from a coil. With the new method there is no production of a closed frame, therefore, there is neither measurement nor joining of the frame's ends. The fastening of the wire or steel strip to the innerspring unit is done after uncoiling and straightening by means of metal clamps.

The process of clamping can take place simultaneously on the upper and lower edge of each side and then the supply is done from two pay-off devices (5), (6) for wire or steel strip, which work simultaneously.

Instead of a single clamping device (press) used by the other methods, in the present invention we use a separate mechanism (press) for every clamping position. This way, the whole process required for the two edges of each side can be done simultaneously in one step or gradually. Besides compressed air, we use hydraulic pressure with which a tighter fastening can be achieved.

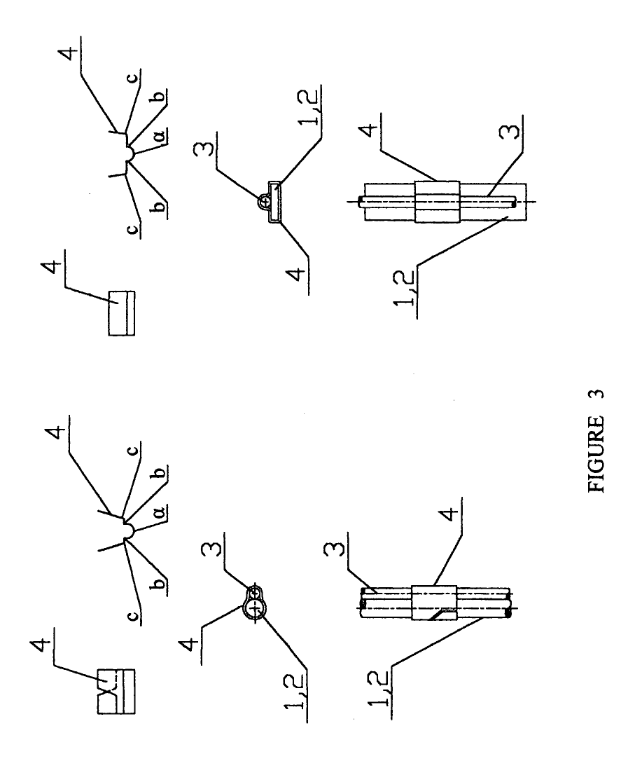

The presses use strip steel clamps (4) for fastening a spring to the frame wire or steel strip, which are produced and preformed by the presses (9), (10) for the two edges of each side respectively. The special feature of the metal clamps (4), FIG. 3 is that they are produced in the shape of the spring's wire and the frame's wire or steel strip with characteristic angles, which copy the cross-section of the wire material and the frame material that after clamping they will fasten and embrace perfectly the two wires or the spring wire and the frame wire or the frame strip steel.

The clamps (4) are stored in a feeder (11) and (12) respectively during the time the edges of a mattress side are being fastened or the mattress is rotated. They are transferred to the presses area by means of the feeder. The press bases translate in order to be positioned against the clamps from where the clamps are picked up. Following this, the press bases translate again to positions against the springs of the innerspring unit to be fastened. At the right point in time, when the presses have the appropriate distance between them, so that they correspond one-to-one to the innerspring unit's springs to be fastened the clamps (4) are transferred into the press tool, so that the fastening of the spring material to the frame material will follow.

The innerspring unit (3) is initially positioned with one of its sides vertically (or inclined or horizontal), so that the side is tangent to the clamping mechanisms (13). Longitudinally, to the right and left of the innerspring unit, there are two guides (17), (18), which can move on a slide, along the axes x-x′ and y-y′.

The guides (17), (18) contact the innerspring unit and determine its length and-or width, and with their vertical position with respect to the fastening mechanisms' (13) axis, force the flexible, elastic, innerspring unit (3) to remain in orthogonal form and in its exact dimensions during fastening.

During the process of compressing the clamps, the measurement of the springs and of the distance between the springs can be done automatically on the side that follows so that this information will be used for press displacement during fastening of the edges of the next side.

This way, after completion of fastening the two frames on all four sides, the innerspring unit is sturdier and can now remain constantly orthogonal, with accurate dimensions.

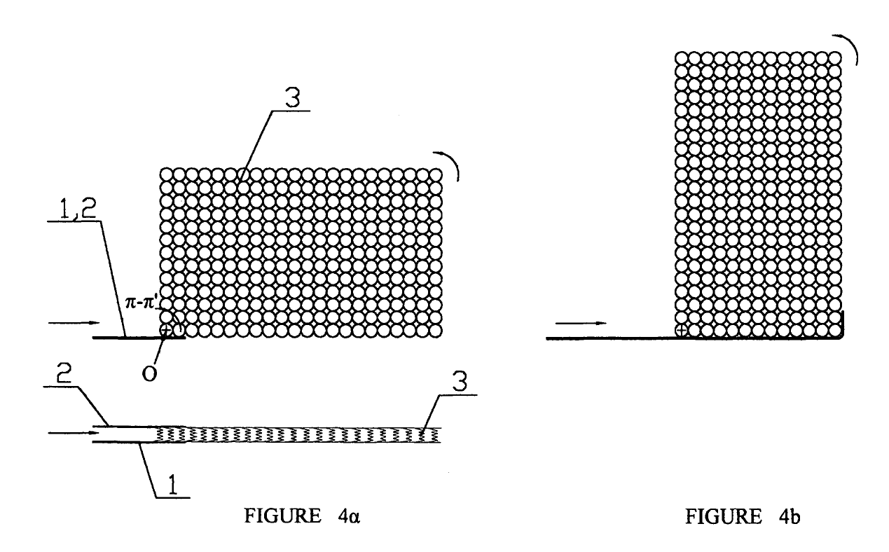

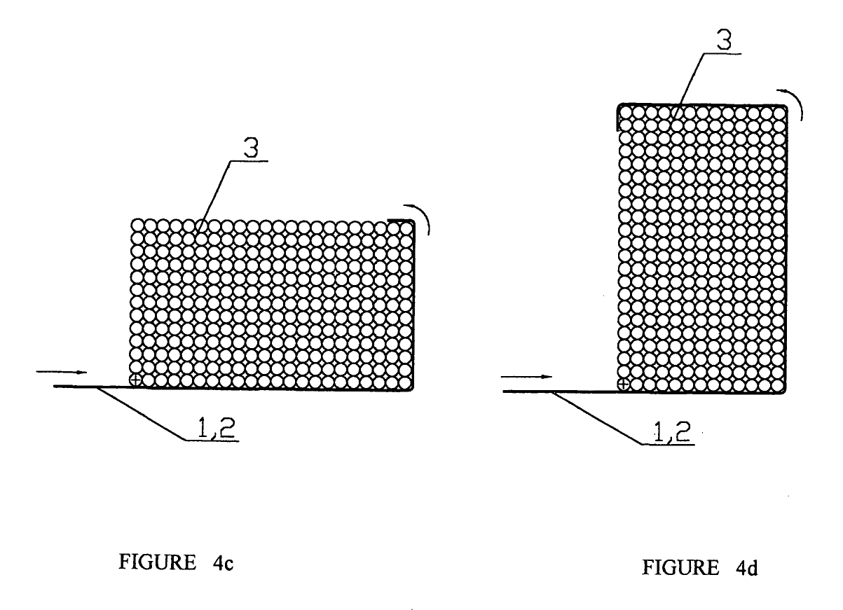

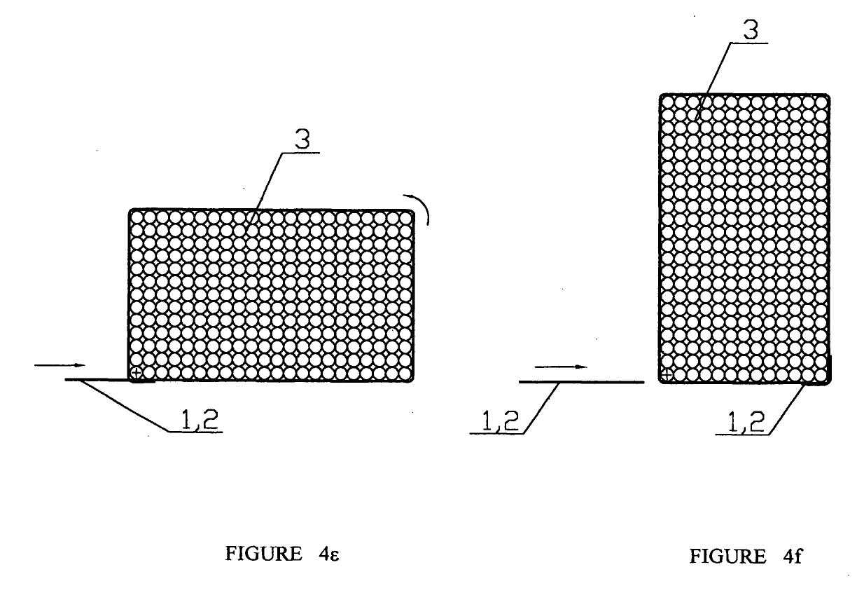

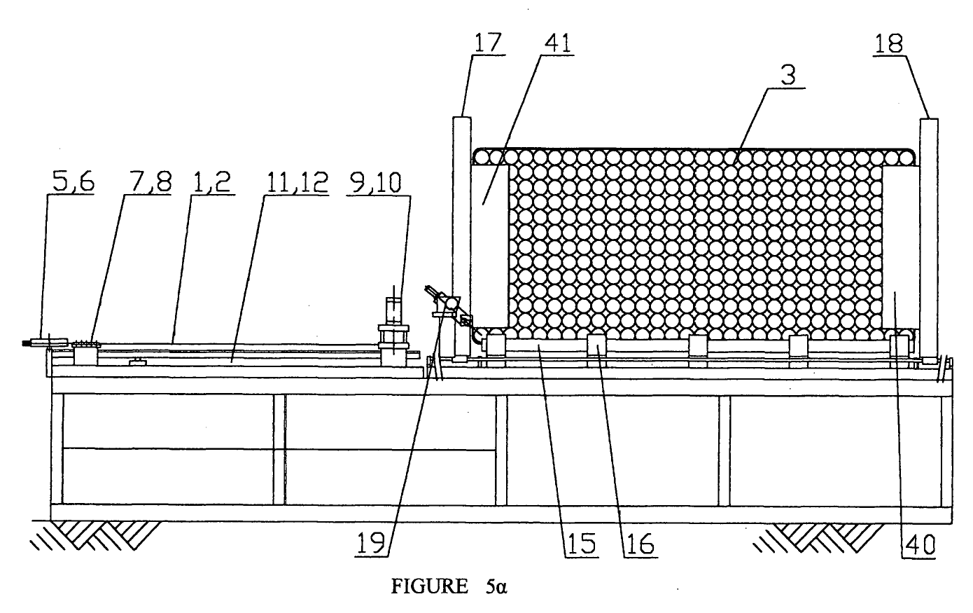

After clamping all positions of one side, the innerspring unit is rotated by the angle required around its end, which is located near the side from where the frame material is fed, following arc ΠΠ′ FIG. 4a, 4b, 4c, 4d, 4e, 4f.

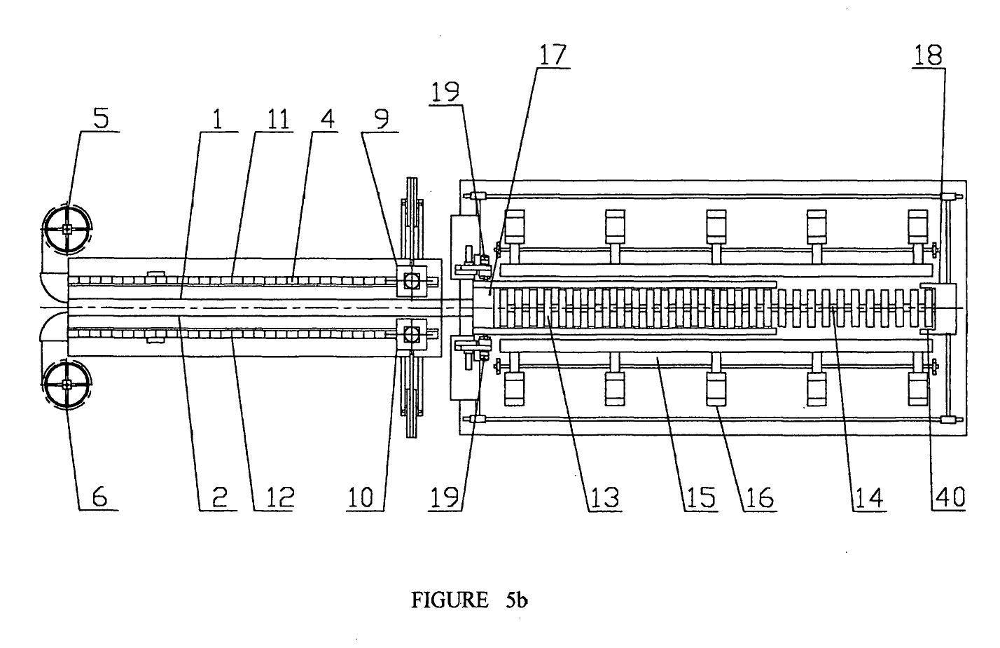

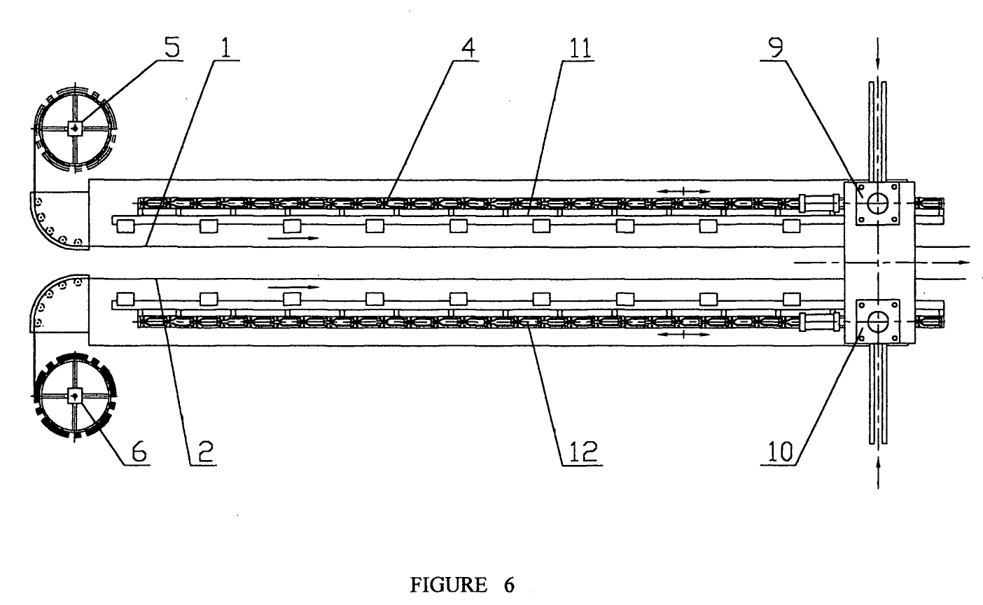

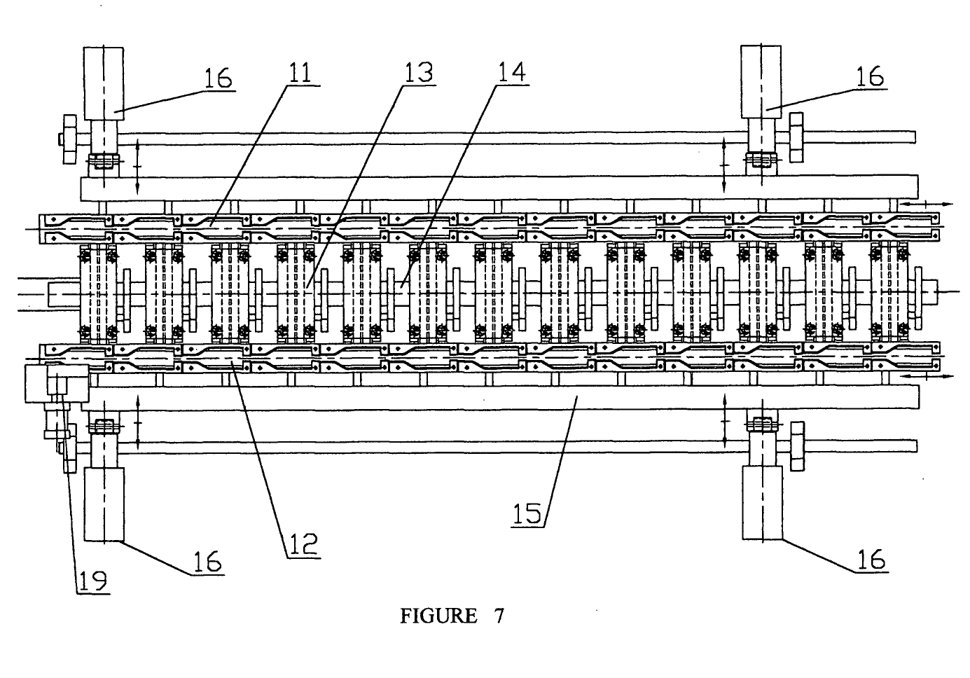

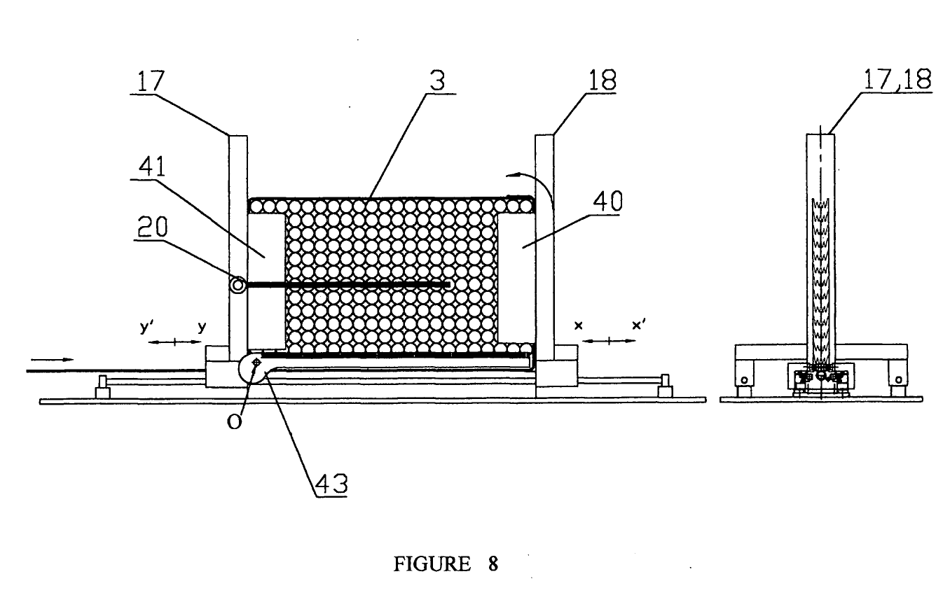

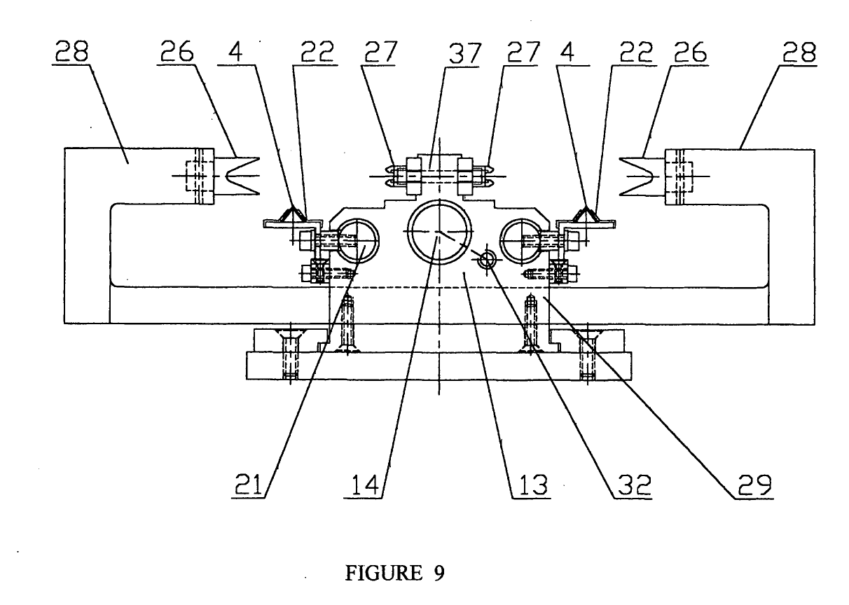

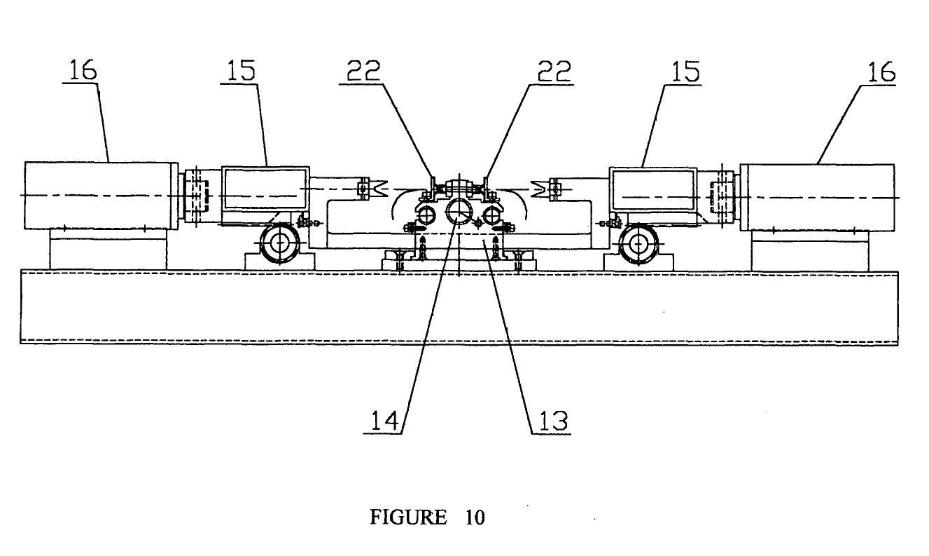

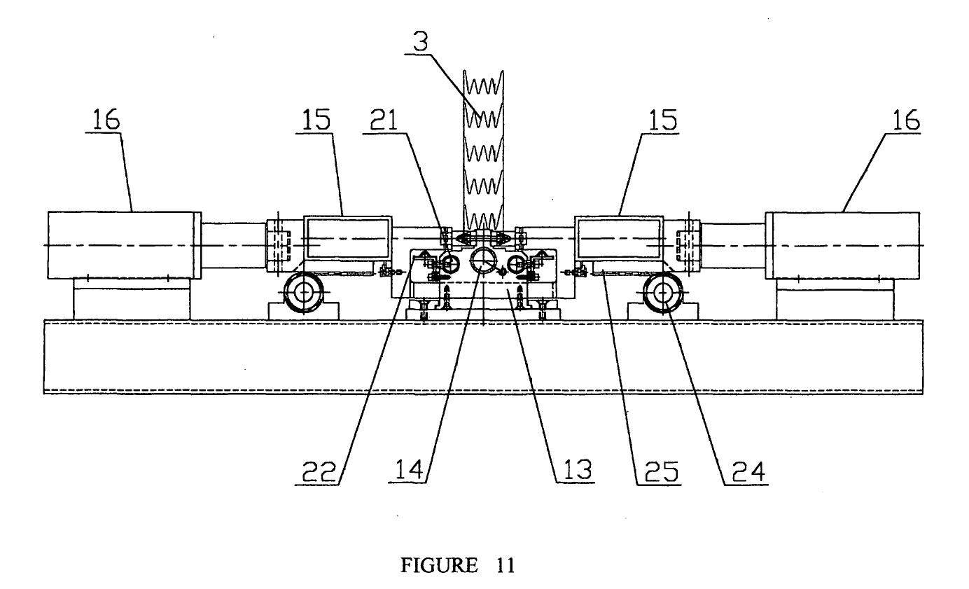

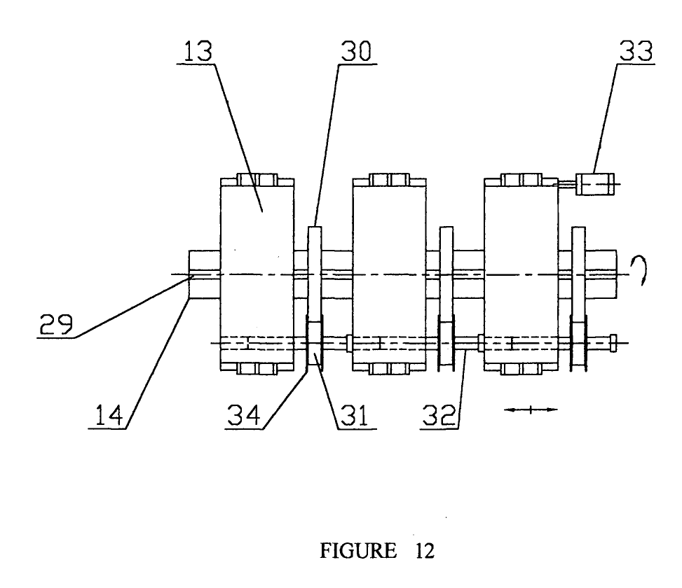

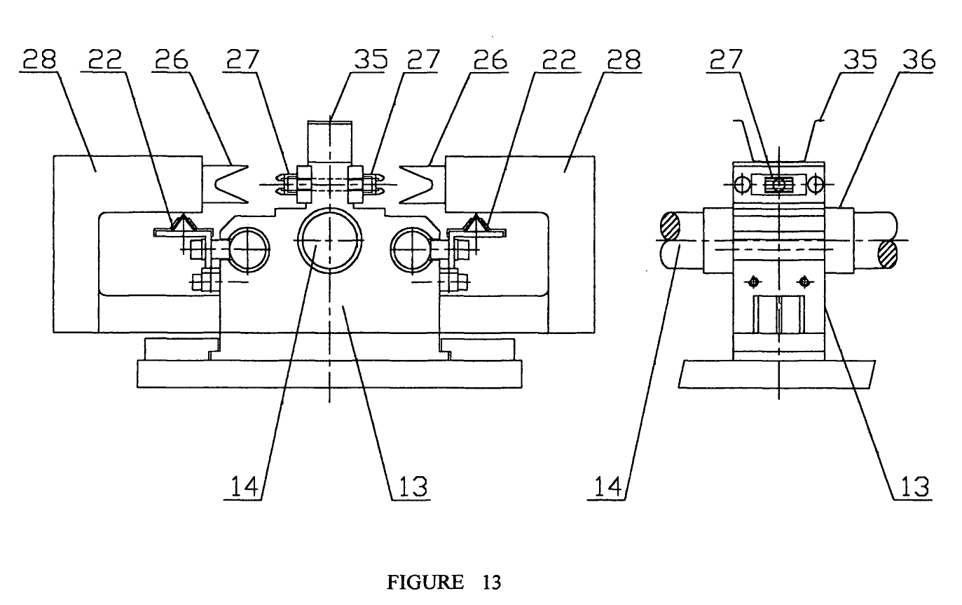

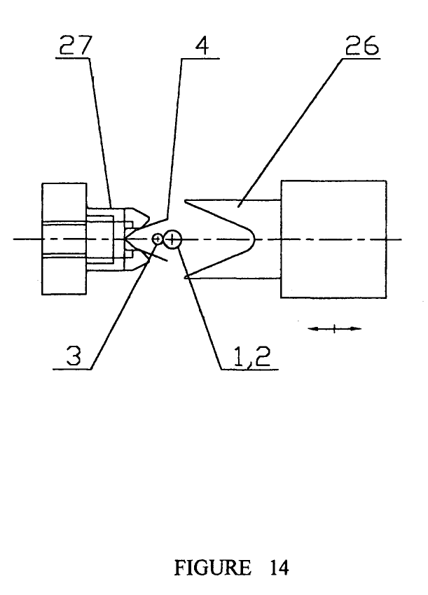

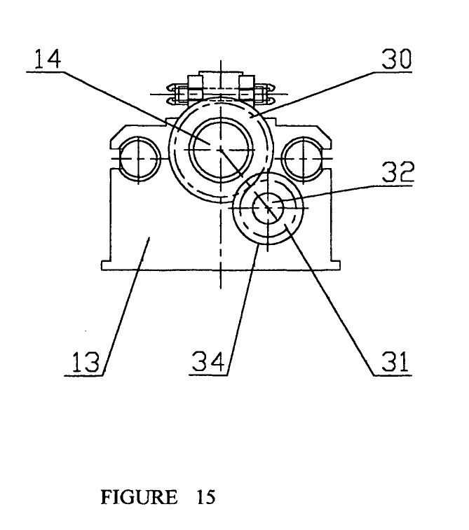

During rotation, bending of the two wires or steel strips (1) and (2) around point 0 also takes place by the required number of degrees by means of the bending mechanisms (19), FIG. 5b. This way, the side of the innerspring unit lines up with the direction of feeding the two wires or steel strips, which are unwound from the pay-off stations.

After this bending operation, the correct side length of the wire frame has been obtained without even measuring since the wire is attached to the side of the innerspring unit and, therefore, has the same length as the side of the innerspring unit and the same happens with the bending angle, which is formed during the unit's rotation and consequently the wire or steel strip obtain the required angle.

In order for the innerspring unit to rotate by an arc ΠΠ′, the left guide (17) moves along y-y′ in the direction of y′ and guide (18) moves along xx′ towards point x′, leaving enough space for the unit to rotate.

Following this, a mechanism (20) with a series of grippers and with and axis of rotation perpendicular to the flat surfaces of the innerspring unit, going through 0 rotates the unit by the desired angle.

At the same time that the innerspring unit rotates, the frame material, wire or steel strip is bent by the bending mechanisms (19), one for each edge. The bending radius is approximately the same as the spring radius.

After completion of the rotation, the two guides contact the innerspring unit and the grippers (40) close, thus holding and making the unit steady in pre-determined dimensions.

Following this, the two guides (17, (18) move simultaneously in direction x′ up to the point where guide (17) brings the lower left spring of the innerspring unit in line with the bending mechanism and up to the point where guide (18) is in a distance to (17) equal to the side of the innerspring unit, which is being fastened. With this movement of the guides, wire or steel strip is pulled at the same time for fastening to the next side of the unit.

This process is repeated until all four sides have been rotated and all of its edges have been fastened to the border material.

The springs making up an innerspring unit have the same diameter but the distance between them may vary along the two dimensions.

Also, for different innerspring units there are different spring diameters. In order for the fastening of each peripheral spring to the frame wire or steel strip to be correct and steady, the press must be positioned in the center of the spring, which is the point at which the spring contacts the frame.

For this purpose, a mechanism is needed for moving the presses automatically to the positions of the springs. At the same time, this mechanism must be able to adjust rapidly to distance changes between springs because, usually, the next side of the mattress, which follows, has a different distance between the springs than the previous side.

We resolved this problem as follows: presses (27), (26) are fastened in pairs on press bases (13), which have a hole through which an axle (14) passes, having a length approximately equal to the longest side of a mattress. The bases with the press pairs slide along this axle. This way, they can take the right positions against all springs to be fastened on each side.

In order to find the right position of each spring center we apply two different methods called the AUTOMATIC and the DYNAMIC method.

Automatic Positioning Method

According to this method, the press bases (13) have, in their hole, a rolling or sliding bearing (36). They, also, have a guide (35) of cylindrical shape with a diameter equal to the spring diameter attached on top of them (13) with an opening equal to the spring diameter.

Therefore, when the innerspring unit approaches the press bases (13), its peripheral springs (3) first come in contact with the internal part of the half circle, which, being under pressure, translates to a point where the spring is entrapped in the circle's deepest point. Consequently, along with the translated bases, the press pairs have also translated and have taken their desired positions at spring center (3).

This is repeated for every side where the distance between springs differs.

Dynamic Positioning Method

With this method we set the distances between presses ahead of time, with mechanical means. Given that the dimensions of the innerspring unit to be processed are known and that spring diameter is also known, we can easily find the positions of the press bases. This is achieved as follows: Axle (14), which goes through the base holes (14), also has a keyway (29) along its length. Between two adjacent bases, along the longitudinal axis, there is a gear (30), which may turn, due to the key (29) and also slide along the axle.

Parallel to the hole axis of each base, there is a screw (32) with one of its ends screwing in and out of the base, while its other end touches the adjacent base and keeps a distance from it.

On the screw (32) there is a gear (31), which is constantly in mesh with another gear (30) on axle (14). The two gears (30), (31) constantly mesh, e.g. by means of two discs (34) on the sides of the one gear (31).

When axle (14) is powered left- or right-handedly, each one of the gears (32) screws or unscrews in its whole length into or out of the bases, creating more or less space between the bases (13) and, consequently, between the presses, which are fastened to the bases.

Due to the fact that the first press is stationary near the innerspring unit's rotation point, every time the longitudinal axis of the mattress is turned, all the bases must move close together or further apart from each other but with respect to the first, stationary base, these distances increase and decrease by doubling, tripling etc. because besides their own movement the bases must move by the sum of the movements of the previous bases which transmit motion by sliding along longitudinal axis (14).

The bases are constantly under pressure by a force, which may be exerted by spring or cylinders (33). This way they are always in contact with the intermediate screws, regardless of whether the distance between them increases or decreases.

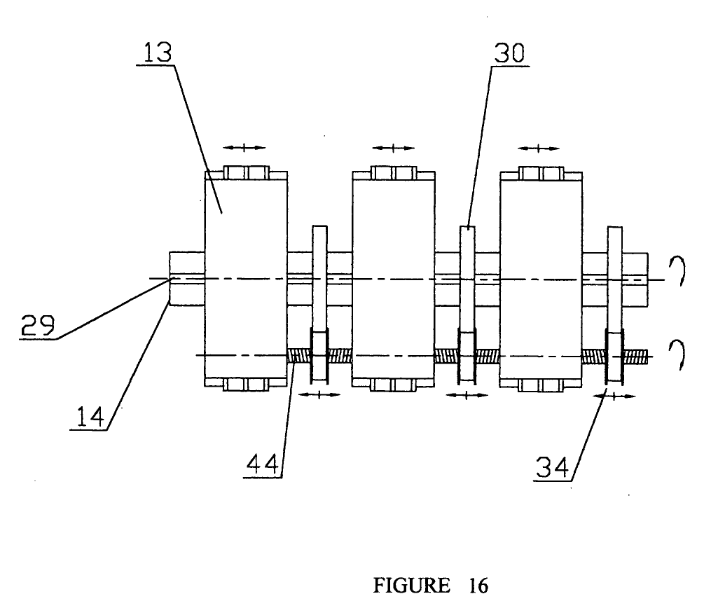

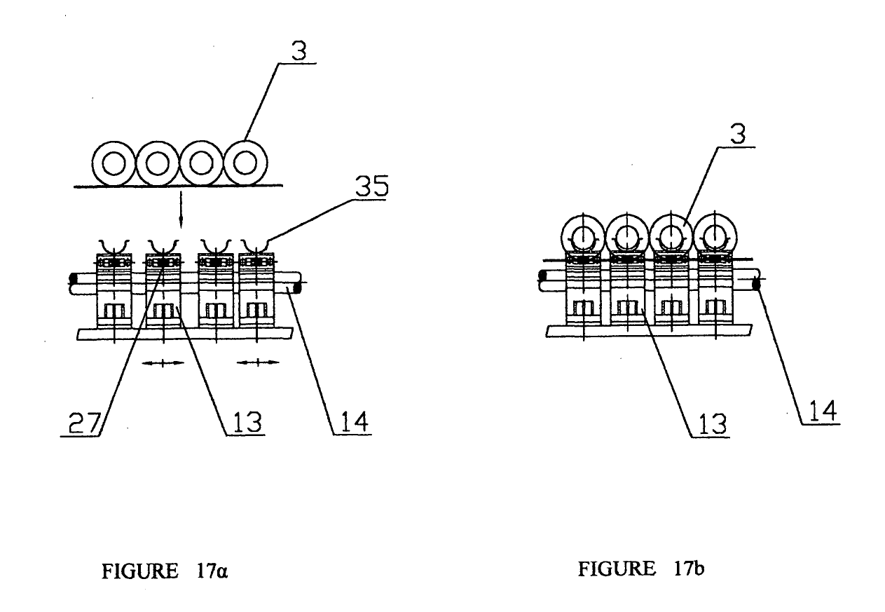

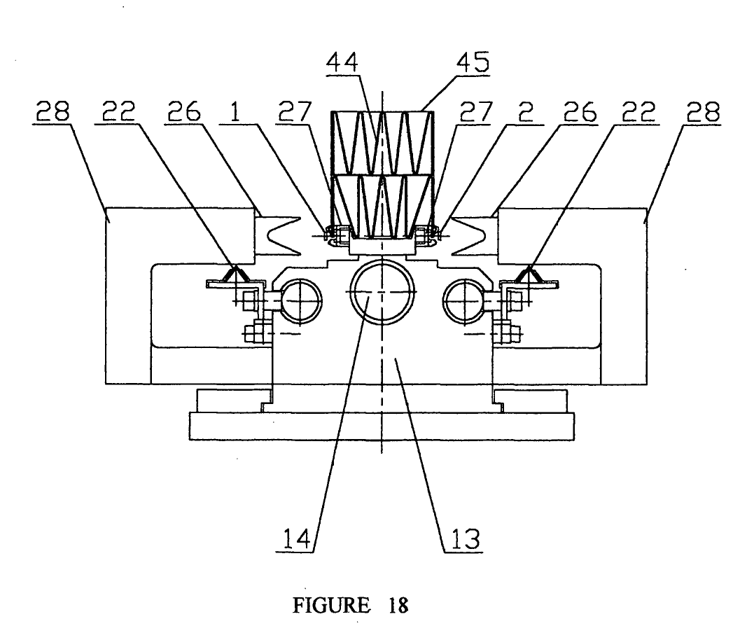

The displacement of the press bases is achieved alternatively FIG. 16, with left-and right-handed screws, which screw into their neighboring bases (13). As axle (14) rotates, the bases come close together or move apart from each other by predetermined distances.

Axle (14) may be in or out of the bases (13) and move the screw in order to set the distances between the bases.

The movement of the bases is done with respect to a predetermined point. If any base (13) is kept stationary, the rest of the bases will move away from it in proportional distances, as the axle rotates.

If different pitch screws (44) are used, the rotation of axle (14) results in different displacements of the bases in a pre-determined proportion.

Base displacement may, also, be realized by using air or hydraulic cylinders for determining the distances between them.

System of Presses

Several types of presses can be used here, one of which is the following: Each press has two parts: the moving parts (28) and the stationary parts (37). On the stationary part (37) there is a die (27) into which a metal clamp (4) is placed, suitable for clamping the frame wire (1), (2) to the spring of the mattress (3).

On every base, there are two similar systems of presses, positioned symmetrically to each other holding the one of the two forming tools (27). They accept the metal clamp, which has already been formed (4) in the right shape to accept in its opening the frame wire or steel strip and the spring, which will eventually be fastened together.

The second part of the press (28) is positioned at a distance to the first (37) in order to leave enough room for the feeder (22) to enter the space between them and position the metal clamps (4) in the cavity of the first part of the press (27). The positioning is done by rotating axle (21), so that the metal clamps are placed in the stationary cavity of the presses.

The second part of the press (28) with its tool (26) is movable and is connected to the first part by means of bridge (29), which slides along a guide in the base (13).

When the second part of the press (28) is pressed by beam (15), which is moved by cylinder (16), it approaches the stationary part, and, at first, covers the open lips of the metal clamps (4) then, due to its shape, makes them close and the clamp entraps the wire or steel strip (1), (2) and the spring (3).

This way, with this massive displacement of the presses on both sides simultaneously, the final result, which is the immediate and simultaneous fastening, is achieved.

The same method and its realization as a machine refer to an innerspring unit with springs, which are in immediate contact with the frame wire or steel strip. The same method and the same machine with minor alterations is applied to the production of the frame and its fastening to innerspring units made with pocketed springs, where the pocket material may be cloth, reinforced paper or any other suitable material.

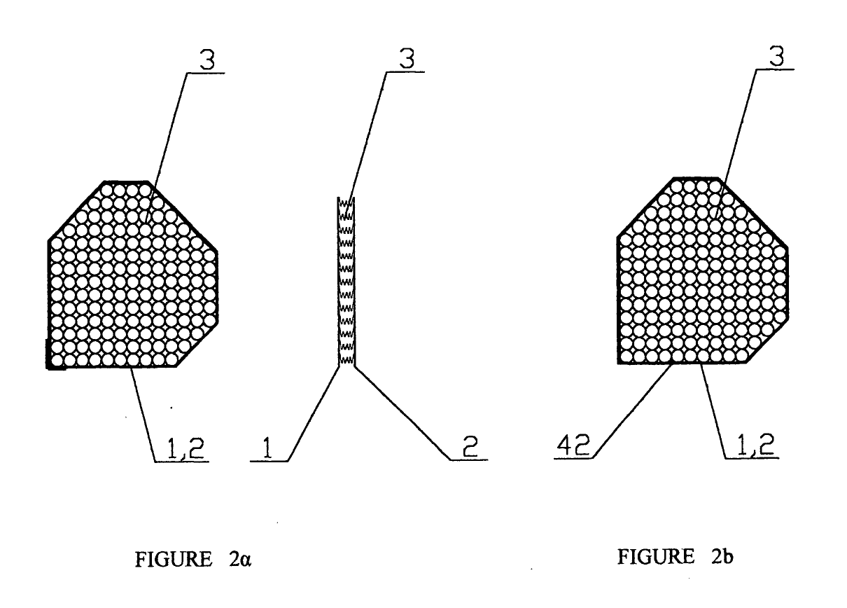

The same method and its realization with only minor changes is applied to the production of non-rectangular innerspring units, but innerspring units with polygonal shapes, as in FIG. 2. The only difference is that the two arms (17) and (18), which support the innerspring unit must change in slope, so that they will adapt to the edges of the innerspring units.

The same method is applied when the frame material, wire or steel strip do not have overlapping ends and the overlapping ends are not fastened to the springs, FIG. 2a, but are welded together, FIG. 2b. In this case, there is a welding mechanism, which can work either with resistance or addition of material.

The connection of the two ends of the frame can be done with a clip after the two ends are positioned in a “but” arrangement. This connection is done by means of a dedicated mechanism, one for each side of an edge.

According to the method developed here, the bending of the frame material is done at the same time the innerspring unit is rotated. Alternatively, in a variation of this method, the bending can be done before or after the rotation of the innerspring unit, as long as the frame material is free in a buffer in order not to deform during bending.

Advantages of the Invention

The product is square, rectangular, stretched or compressed to its exact dimensions, due to its forced positioning during the immediate and simultaneous fastening—clamping of each side (two edges simultaneously).

The fastening of the springs to the wire or steel strip is done with metal clamps, which are produced specially for each combination of frame that are produced specially for wire or steel strip and spring wire. This way, a perfect clamping and fastening is achieved between framed wire or steel strip and spring wire.

It eliminates intermediate operations with known methods and machines like frame production, intermediate storage, transportation to the fastening device, fastening by means of a dedicated machine.

Very fast method and machine, since it can fasten simultaneously two edges of one side, or more than one sides.

Completely automates frame production and its fastening to the innerspring unit, which is made of interconnected springs and the frame material is wire or steel strip.

Description of Operation

The machine described above functions as follows: An innerspring unit is manufactured by the appropriate machine. The innerspring unit is made of springs connected to each other by means of a spiral or is made of pocketed springs. In order to gain stability in dimensions and shape, the innerspring unit is framed by a material of high resilience in plastic deformation, which has a prismatic cross-section.

The innerspring unit is positioned by the operator between two guides (17) and (18). The press (26, 27), which is situated at the rotation point and the one closest to it are already loaded with clamps. The arms (43) compress the row of spring, which is between the presses. The spring that coincides with the rotation axis and the one next to it are fastened onto the frame material. At the same time, the length and the distance between the springs of the side against guide (17) are measured—this is the side that will be processed next.

During clamping, presses (9) and (10) pull strip steel from their respective rolls, they cut and form the clamps. Next, the clamps are placed on the respective carriers (11) and (12), which transport the clamps to the area of the presses.

After clamping, guide (17) moves, leaving room for the innerspring unit to rotate. The arms (43) rotate, taking with them the innerspring unit and forming the frame material, which is bent by the respective tool (19). Guide (20) keeps the mattress surface flat during rotation.

After completing the rotation, guides (17) and (18) move towards the innerspring unit, and as soon as they have made contact with it, grippers (40) and (41) close. Following this, the guides move towards the presses and stop as follows: (17) stops at a given point, which is constant and assures that the next rotation will take place around around the center of the corner spring, 18) stops at the point dictated by the nominal dimensions of the innerspring unit (this way, the mattress is compressed or stretched to its specified dimensions). Furthermore, this displacement results in pulling frame material from the rolls for use in fastening the next side.

During the rotation, the press bases are arranged in such a way that the distances between them correspond exactly to the distances between the clamps as the clamps are positioned on their carrier. As the innerspring unit returns to the clamping position, the clamp carriers move towards the presses, where they place the clamps on the stationary parts of the presses (27). After placement of the clamps, they move in the opposite direction in order to repeat clamp pick-up.

Following this, the press bases take their positions based on the measurements taken on the side to be processed during clamping of the previous side. At the end of this operation arms (43) press the respective springs towards the stationary parts of the presses. This way the presses' moving parts can move towards their respective stationary parts, thus compressing the clamps. This cycle is repeated until there is a small overlap of the frame material's one end by the other or until its two ends are welded together.

1. Method for the fastening of metal frames, of any cross-section or shape onto the edges formed by the outer surfaces of innerspring units, which are made of springs, which springs are interconnected by means of a spiral wire or are pocketed in cloth or non-woven material, which method is characterized by the fact that the total number of required clampings corresponding to each one of the peripheral springs along the edges of each side or more than one sides of the innerspring unit is done by means of presses, equal in number to the number of springs to be fastened and, which presses are actuated simultaneously or gradually; by the fact that the metal frames, which are made of wire, which frames are fastened in the periphery may be ready made or may not need a previous measuring, bending or joining operation; by the fact that these frames are formed as their material is unwound from a roll; by the fact that the required bending of the frame material for the frame to conform to innerspring unit corners may be done after fastening on the edges of each side, where the fastening is done by press pairs equal in number to the number of springs that will be fastened, which presses are secured on bases, which bases can translate and take positions at the center of the springs to be fastened, where a clamp carrier system delivers the clamps to the presses, which presses translate with an automatic or mechanical method; by the fact that fastening is done by means of pre-formed clamps, which are transported and placed in the cavity of every press, where the corresponding metal wire and respective spring enter, the other part of the press approaches then, compresses, entraps and fastens; by the fact that before fastening the length and distance between springs of each side are measured; by the fact that after fastening, the mattress is rotated around one of its corners and then bending of the two frame wires is accomplished, which bending may happen earlier; by the fact that there are two guides, which keep the innerspring unit in an orthogonal position where the guides move away from the mattress during rotation; by the fact that the innerspring unit, after rotation, moves along with the two pieces of wire, which are fastened to its edges taking a position with its next side along the presses; by the fact that two arms, one on each surface of the edges under processing in an arrangement parallel to the presses compress the whole row of springs of each edge under processing so that the springs enter the press cavities.

2. A method according to claim 1, characterized by the fact that the frames are fastened simultaneously or gradually onto the springs of each edge of the innerspring unit as the number of presses corresponding to the springs is activated.

3. A method according to claim 1, characterized by the fact that the bending of the frame may take place before or after mattress rotation.

4. A method according to claim 1, characterized by the fact that the clamps are pre-formed and have a shape of straight and curved surfaces, which perfectly embrace the frame wire and the spring wire after pressing, thus forming a lasting connection.

5. A method according to claim 1 characterized by the fact that the clamps are produced, formed and stored or are already formed and are stored; by the fact that they are transported to specific locations in the presses area with a carrier mechanism, where the presses take the right positions in order to be next to the clamps; by the fact that the clamps are placed into one of the presses' tools; by the fact that the presses then translate to positions next to the springs that will be fastened so that fastening of the frame to the springs will take place.

6. A method according to claim 1 characterized by the fact that the clamps are produced, formed and stored or are already formed and are stored; by the fact that they are transported to specific locations in the presses area with a carrier mechanism next to the presses, where the clamp carriers translate to the right positions in order to be next to the presses, where a mechanism places the clamps onto one of the presses tools, so that fastening of the frame to the springs will take place.

7. A method for the relative displacement of press bases characterized by the fact that the bases move, as they are supported by and axle by means of a bearing, at the same time screw screws into the base, parallel to axle, there is also a gears on the axle, which gear may slide along axle with the aid of a key on the axle, which gear is always in mesh with a second gear on the screw, so that when the axle rotates, the screw also turns, thus crewing into or our of the base and causes the distance between the basest to increase or decrease with the bases being constantly in contact with each other by means of the screws as they are under pressure by the external force.

8. A method according to claim 7, characterized by the fact that the press bases move by means of a mechanical arrangement, as an axle rotates and positions them at the locations where the springs are.

9. A method according to claim 1, characterized by the fact that the press bases have the right guides, which are made according to spring geometry and which bases automatically align with the springs to be fastened as they are pushed towards the springs.

10. A machine according to claim 1, characterized by the fact that a series of press pairs positioned so that they will fasten the wire or steel strip frame to the innerspring unit springs simultaneously or gradually on both edges of one side, or on more than one side using as a fastener a clamp suitably cut to size and formed by presses which clamp is stored and fed by a mechanism to the fastening points; by the fact that the wire or strip steel are fed from coils and are led to the fastening points; by the fact that the press bases are displaced with mechanical means to positions next to the springs to be fastened including a suitable mechanism, which is moved by a rotating axle, which positions may differ from the one side of the mattress to the other, or the bases may be displaced automatically through the proper shape of the press basest by the fact that the spring positions are detected automatically by a, measuring system, or the positions of the press bases may be programmed; ahead of time; by the fact that the innerspring unit is entrapped between two guides, so that it is square during fastening; by the fact that two arms compress the innerspring unit in order for the spring wire to enter the press tools and that the arms rotate the innerspring unit with respect to a constant point of rotation, while the bending mechanisms may bend the two frame wires simultaneously by the desired angle.

11. A machine according to claim 1 characterized by the fact that the press bases carry two symmetrically positioned presses, which are activated as they are pressed by any source of force in order to fasten the two edges of a side.

12. A mechanism according to claim 7, characterized by the fact that the press bases translate as they are supported on axle by means of a bearing while a screw screws into the press base, parallel to axle and there is also a gears on the axle, which gear may slide along the axle and key, which gear is constantly in mesh with a second gear, which second gear is on the screw in such a way that when the axle rotates, the screw also turns, thus screwing into or out of the base and causes the distance between the basest to increase or decrease with the bases being constantly in contact with each other by means of the screws as they are under pressure exerted by the external force.

13. A mechanism according to claim 7 characterized by the fact that the press basest translate as they are supported on guides by bearings and simultaneously a screw screws into the base parallel to axle, which axle is in the bases, there is also a gear on the axle, which may slide along axle and key, which gear is constantly in mesh with a second gear, which second gear is on the screw in such a way that when the axle rotates, the screw also turns, thus screwing into or out of the base and causes the distance between the bases to increase or decrease, with the bases being constantly in contact with each other by means of the screws as they are under pressure exerted by the external force.

14. A mechanism according to claim 7 characterized by the fact that the screws between the press bases screw into both of their neighboring bases by means of an element that has a left- and right-handed thread so that when the axle rotates, the bases move with respect to each other keeping the correct distances between them without the need of an external force.

15. A machine according to claim 1, characterized by the fact that the press bases move with respect to each other in a predetermined fashion under the effect of the central transmission axle.

16. A machine according to claim 1 characterized by the fact that the press bases are supported on an axle by means of a bearing, on which axle the bases can freely move and align automatically with the springs to be fastened with the aid of a suitable guide on each base, which guide has a concave surface in order to embrace the spring of the innerspring unit, so that when the base approaches the springs, the base automatically moves to the right position as it self-centers to its respective spring.

17. A machine according to claim 1 characterized by the fact that the innerspring unit is entrapped between two guides, where guide moves along the length of the frame wire and can move away during the rotation of the innerspring unit and where guides have grippers for holding on to the innerspring unit.

18. A machine according to claim 1 characterized by the fact that the clamps are produced and formed on the machine itself with flat and curved surfaces in order to perfectly fit to the combination of frame and spring wire and steel strip and spring wire in order to effect a steady and strong clamping.

19. A machine according to claim 1, characterized by the fact that the clamps are produced and stored in a clamp feeders, they are transported to the area of the presses and with a rotating motion they are placed into one of the two forming tools of the press.

20. A machine according to characterized by the fact that two arms compress the innerspring unit in order to position the springs in the presses tools for fastening them to the frame wire.

21. A machine according to claim 1 characterized by the fact that all presses are activated simultaneously by an activating force, which pushes a beams, which in turn pushes the presses.

22. A mechanism according to claim 1, which connects the frames on the periphery of innerspring units, which are made of springs pocketed in cloth or non-woven, where the upper part of the stationary member of the press compresses the sheet material, which changes in shape, so that the incoming frame can be fastened by the press, thus entrapping the cloth between the spring wire and the frame wire.

23. A product according to claim 1, characterized by the fact that the springs of the innerspring unit are fastened to two wire or strip steel frames, so that the innerspring unit is forced to take specific dimensions as it is pressed by guides and both edges of one side are fastened simultaneously, the clamps are produced specially for fastening the particular spring and they have a specific shape, form, edges, and contour such that the clamps will perfectly embrace the wires to be fastened together or the spring wire and the steel strip frame in order to form a strong connection between frame material and spring.
